(19) United States
(12) Patent Application Publication
(10) Pub. No.: US 2010/0153287 A1
(43) Pub. Date: Jun. 17, 2010

(54) METHOD AND SYSTEM TO TRANSITION A PERSON FROM DIAGNOSIS TO WELLNESS

(76) Inventor: Roger Holzberg, Studio City, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 12/631,474

(22) Filed: Dec. 4, 2009

Related U.S. Application Data
(60) Provisional application No. 61/138,032, filed on Dec. 16, 2008.

(51) Int. Cl. G06Q 99/00; G06F 3/048; G06F 17/30

(52) U.S. Cl. 705/319; 707/792; 715/810; 707/736; 707/769; 707/E17.044; 707/E17.014

(57) ABSTRACT

A system and method that guides patients, caregivers and supporters or individuals as they confront, and endeavor to overcome, a serious health crisis or major life transition. The system facilitates the reduction of the overwhelming psychological nature of the diagnosis event by compartmentalizing it into manageable phases, based on distance from diagnosis, enabling a patient to overcome and quickly envision their first step toward wellbeing. The system then facilitates the building of an online community and social media network, using templates to help patients, caregivers, or supporters and individuals set goals and acquire community wisdom, that leverages the unique nature of the phases, from diagnosis to treatment to recovery to wellness. The system automatically transforms the templates into a printed chronological journal that serves as an organizer, note and record keeper, medical communication tool, and a progressive documentation of the patient, caregiver, supporter or individual's story.

This application claims the benefit of U.S. Provisional Patent Application Ser. No. 61/138,032, Filed Dec. 16, 2008, which application is incorporated herein by reference in its entirety.

### FIELD OF THE INVENTION

The invention relates to the merging of an online social media application, or social network, with a personalized guide for wellbeing, and the technology that enables these two objectives to fully integrate with one another.

The computer software enables patients, caregivers or supporters and individuals to establish personal needs, goals, and records on a social media application, then share that information with members of their online community, for the purpose of collaboration, validation and recommendations to help the patient achieve personal wellbeing.

### BACKGROUND OF THE INVENTION

The Internet has become an invaluable resource for those seeking wellness or help in life transitions. Research shows, for example, that the use of “online communities . . . by people experiencing breast cancer has been associated with lower levels of depression and improved quality of life” (Threading Together Patient Expertise, Andrea Civan, Wanda Pratt, PhD, Medical Education and Biomedical Informatics, University of Washington, Seattle, USA, The Information School, University of Washington, Seattle, USA).

However, there is no one source for a comprehensive method and system of support and guidance and specific/individualized real world survivor tips.

None of the existing sites combine robust functionality designed for personalized online and offline information management with community-based user-driven communications tools.

Existing websites can be grouped into three main categories
Health information sites
Patient/family/friend sites
Vertical sites dedicated to a single disease or condition

While many of these sites offer excellent features, this invention empowers patients, caregivers or supporters, and individuals to take control of their own wellbeing and work proactively and productively with their health care providers and their community.

The best of the informational sites include Revolutionhealth.com and WebMD.com. Primarily used for research, these sites provide access to a broad range of health-related information, searchable databases and referrals. However, they do not offer any personalized tool set to empower patients or their caregivers to manage their health care, nor do they provide any opportunity to create a personal community of support.

The second category includes Caringbridge.com, Dailystrength.com and Patientslikeme.com. These sites primarily offer a way for patients, family and friends to stay in touch during a health crisis, publish notes that include medical stats and medical histories, whether through a dedicated, user-generated website, or through blogs and chat rooms. These sites do not offer any guided online or offline tools for the patient to manage their health treatments and healing.

The third and largest category includes sites dedicated to a single disease or condition. Sites include the American Cancer Society's Cancer.org, American Heart Association's Americanheart.org, Lance Armstrong Foundation's Livestrong.org, and Alzheimer Association's Alz.org, to name just a few. These are nonprofit sites, and while they do offer tremendous value to their users, they do not provide any personalization, any online or offline tools to manage health care, nor any user-generated personal community.

None of the existing solutions combine all of this invention's attributes to provide a comprehensive method and system for users. None offers the phased approach. None offer a Tips 4 Life module that disseminates best practices from all illness to all users, regardless of current illness or diagnosis. Furthermore, not a single one of the existing sites offers the feature of a customizable, personalized printed book version of the entire plan that the patient and their community build along the way, chronicling the patient's chronological journey in a written, chaptered sequence. While technology and websites are often useful, when patients, caregivers or supporters and individuals operate in real world situations they tend to use offline tools. In this regard, this invention's printed Bridge Book feature is a compelling and important differentiator.

To summarize: In the current environment, the vast majority of online Health products are:
1. Disease specific—for example, Livestrong—cancer, the American Cancer Society—cancer, The Diabetes Foundation—diabetes, etc.
2. Generalized in terms of time and distance from diagnosis—the health websites that embrace multiple diseases are generic in terms of allowing patients, caregivers or supporters and individuals to post their information
3. Generalized in terms of recommended patient wisdom—online patient and caregiver users self search through the generalized questions and answers—not systematically generated to match not only your disease but your current phase of your disease as with My Bridge 4 Life
4. Exclusive and linked to an internet enabled computer—The method and system and social networking elements are resident to the computer environment
5. Void of incremental goals for patients, caregivers or supporters and individuals that help reduce the overwhelming nature of the process

This invention encompasses a thoroughly integrated method and system that addresses all of the above problems in a single solution.

### BRIEF DESCRIPTION OF THE INVENTION

Each day, regular people learn that their life is about to change because of a health related diagnosis or other challenge. While there are a number of support groups for many of these specific challenges, this invention is easy to remember, easy to use and it works for any health crisis or major life transition.

This method and system to transition a person from diagnosis to wellbeing is a single, organized source for users to keep track of the important treatment options being offered and their equally important personal progress and emotional well being during their challenge.

This method and system to transition a person from diagnosis to wellbeing can be used for any disease or condition and has the potential to help millions of people. As an example, the National Cancer Institute estimates that approximately 10.8 million Americans with a history of cancer were alive in January 2004. About 1,437,180 new cancer cases were diagnosed in 2008. Add heart disease to those figures and, according to the CDC, another 24.1 million Americans need help.

One of the important aspects of this invention is the support the patient needs, expects and receives from family and friends. These family and friends will be invited to access the site and be given a password that enables them to view and enter data, as the patient permits, via patient “blogs”.

The user groups and individuals are further defined as:
1. Patient—Any person facing a life threatening illness or major transition challenge; with illnesses such as cancer, heart disease, diabetes, depression, or transitions like loss of a
2. loved one, or transition from active military duty to civilian life.
3. Caregiver or Supporter—Any person in support of a patient or patient group that is seeking to transition from diagnosis to wellbeing. Caregivers or Supporters can also include therapists, caseworkers, researchers, students, hospice nurses, general nurses, healthcare professionals, friends and family, etc.
4. Individuals—Any person seeking to help facilitate wellness in a friend, acquaintance, group, or themselves.
5. User—Any person who uses the system.

Caregivers and Supporters have special responsibilities and needs of their own. Caregivers will be invited to access a patient's site and add their own thoughts and comments. They may also be required to input information on behalf of the patient.

This method and system to transition a person from diagnosis to wellbeing is especially helpful for professional caseworkers, therapists, researchers, and healthcare professionals, because they can learn and understand a patient's goals and mindset without guesswork.

This invention has several unique inventive features not present in any sites now available:
1. Disease generic (able to be applied against any life-threatening disease): it works for every challenge.
2. Phased approach that is specific to the distance from diagnosis and is not general.
3. The phased approach allows for tips and wisdom to be targeted at the patient's specific needs of the moment.
4. The generation of a real world book, that can leave the computer and take the form of a personal organizer/planner and scrapbook, to help the patient/caregiver anytime—at a friend's house, at the doctor's office or at the kitchen table
5. Facilitates the setting of incremental goals for each phase. The progressive goals enable the patients, caregivers or supporters and individuals to make progress and have a sense of moving forward with self-determination.

By breaking up the experience into phases, treatment doesn't seem so overwhelming. The phases also allow patients to mark their progress and, as they connect with other patients, they can form a stronger sense of community and support, which reduces feelings of isolation.

This invention is a system and method that guides patients, caregivers or supporters, and individuals as they confront and endeavor to overcome a serious health crisis (or major life transition). The system reduces the overwhelming negative psychological nature of the diagnosis event by compartmentalizing it into manageable phases (based on distance from diagnosis), enabling a patient to overcome and quickly envision their “first step” toward wellbeing. The system then facilitates the building of an online community to help the patients, caregivers or supporters and individuals set goals and acquire community wisdom, via Tips4Life, that leverage the unique nature of the phases (from diagnosis to treatment to healing to wellbeing). The online site automatically transforms the patient/caregiver's online community templates into a printed journal that serves as an organizer, patient/caregiver note and record keeper, medical communication tool, and a progressive documentation of the patients, caregivers or supporters and individual's story.

This invention provides the following advantages:

1. Disease Generic. The vertical approach to online health guides (as exhibited by many of the existing offerings in the market) fail to embrace the holistic nature of human illness. Often, complications in one medical condition trigger other challenges for patients in other areas. For example, a suppression level dose of Synthroid for Thyroid hormone replacement can cause loss of calcium and decrease bone mass as a side effect—therefore a thyroid cancer survivor could benefit from learning provided by someone facing Osteoporosis. As another example, bone mass loss in men can be reversed by testosterone replacement, but that treatment can trigger a rise in PSA levels and the patient might benefit by greater understanding of Prostate and PSA markers. A very common example is that patients with heart diseases often have complicating factors with diabetes.
a. This method and system, to transition a person from diagnosis to wellbeing allows patients, caregivers or supporters and individuals to search a disease-generic database, provided other users who have been there themselves, allow access to their sites.
b. (If permission has been granted by the user) the invention facilitates the ability of patients, caregivers or supporters and individuals to read the detailed descriptions of broad symptoms and cures that may relate to their condition, but is not specific to their diagnosis, and to contact them directly for collaboration and learning from personal experience.
c. (If permission has been granted by the user) the invention facilitates the ability of patients, caregivers or supporters and individuals to connect via email with other patients, caregivers or supporters and individuals to gain support and learning's across a broad spectrum of symptoms and cures that may relate to their condition, but are not specific to their diagnosis.

The principal method by which the patients, caregivers or supporters and individuals gain disease generic learning's is by taking the following individual steps:
select the Tips4Life section in the global persistent navigation
use the filter tool on the Tips4Life module to select an
   illness
   phase
   age range
   location
   NOTE—The “illness” pulldown menu includes all illnesses that are present in the community
select Patient, Caregiver, Supporter or Individual status
select the Submit function to get the result

The software will then query the global database and cause the user's filtered request(s) to be displayed. The person can then browse the filtered results to find the result that is most relevant to their personal condition by reading the brief descriptions attached to each of the queried findings. By selecting a single finding the user can then visit that patient, caregiver and supporter or individual's plan and gain the disease generic learning's desired.

2. Phased approach: As an important differentiator from the way other health and wellbeing online sites seek to help patients, caregivers or supporter and individuals with advice or information, this method and system to transition a person from diagnosis to wellbeing uses a phased approach vs. a generic approach. As an example of the reason why this is significant: the needs of a patient four days after diagnosis may be focused on dealing with the best ways to find and validate a surgeon, whereas a patient four years after diagnosis may be dealing with the best diet and exercise routine for their long term prevention program.

By breaking up the experience into phases, treatment doesn't seem so overwhelming. The phases not only allow patients to mark their progress, but also, as they connect with other patients, they can see similarities; and they can greatly benefit from Tips4Life along the way. The result is a stronger sense of community and support, which reduces feelings of isolation

### Phases:

Diagnosis—from diagnosis to the decision of what the first path of action will be
Treatment—from decision of what the first path of action will be to completion of the first path of action
Healing—from completion of the treatment, through 310 the duration of the following (as/if needed): additional treatments, through the setting of (3) goals for the next year in a Bridge Plan
Wellbeing—begins 1 year after the setting of the goals and celebrates the achievements of the year; then new goals are set for the following year and the process is repeated yearly becoming the foundation of the patients, caregivers or supporters and individual's “Bridge Plan 4 Life”

The principal method by which the patient, caregiver or supporter and individual utilizes the Phased Approach is:
The very first desired user action is to print the Start-up Guide which is a step by step instruction of how to use the system and method and how to approach the phased process
If the patient, caregiver and supporter or individual has just received a diagnosis, they are in Phase 1, Diagnosis Phase (if they are in a latter phase they are prompted to retroactively enter the data in the template for Phase 1).
They enter:
   Who Am I?—Personal information, illness, caregiver vs. patient vs. supporter vs. individual
   Goals—Personal goals that the user desires to accomplish in this phase
   My Medical—User enters the contact information for the Medical resources and notes on healthcare directives
   Community—Patients, caregivers or supporters and individuals are prompted to enter name, relationship and expectation for each Supporter, and set a permission level for the person to view all or a limited amount of their Bridge Plan
   Tips4Life—At the end of Phase 1 the patient/caregiver is prompted to share their own experiences—what has worked (or what hasn't)
   Blog Pages—The patient, caregiver and supporter or individual is prompted often to share, validate and “tune” their goals, physicians and physician choices, and more, and also to validate their own tips and goals with their community.
   My Bridge Book—Patients, caregivers, and supporters or individuals are encouraged to print their Bridge Books, chapter by chapter, and assemble these chapters in a notebook to be used as an organizer, resource, journal and life affirming chronicle of their wellbeing journey.
   NOTE: In the event that the patient does not live past the early phases, the Bridge Book is then used as a memory book.
The same process is repeated for each of the latter three Phases; Treatment, Recovery, and Wellbeing.

3. Tips4Life. The method and system has a section of the online social media application (or social network) which provides a sub system and method for searching, receiving and posting health and wellbeing tips in each of the four phases. Research has proven that patients find great value in real-world experience and advice from people like them. The phased approach of the method and system enables patients, caregivers and supporters or individuals to find extremely well targeted information quickly.
a. The system provides a method to search Tips4Life by specific phase to give patients, caregivers and supporters or individuals very precise recommendations (from other community members) on the best ways to get through the challenges of the phase they are currently experiencing.
b. The system provides a method to syndicate Tips4Life to digital devices and online applications with greater specificity because the information is linked to a phase.
c. The system provides a method for patients, caregivers or supporters and individuals to upload their own Tips4Life to be published and shared for the benefit of the larger community.
d. The system provides a method for patients, caregivers and supporters or individuals to filter Tips4Life by age, location, illness and phase.
e. The system provides a method for patients, caregivers and supporters or individuals to save relevant Tips4Life in a favorites section.
f. The phased approach provides a method and system that enables advertisements and recommendations to be targeted to exact need states that patients, caregivers and supporters or individuals are currently experiencing.

The principal method by which patients, caregivers and supporters or individuals access and utilize the Tips4Life functionality is:
Upon login, the patients, caregivers or supporters and individuals are asked to identify a minimum amount of information about their “need state”. The required fields are name, email, illness, patients, caregivers and supporters or individuals, age range, location. After entry and submission of this information the software automatically searches the community database and syndicates the closest matches of Tips4Life to the patients, caregivers or supporters and individual's query.
If the patient, caregiver or supporter and individual so elects, they can choose to have the Tips4Life syndicated to their mobile device or personal computer desktop, as well as other social media and social networking sites like Facebook, MySpace, Twitter, etc.
The user can also adjust the parameters of the Tips4Life as needed. For example, patients, caregivers or supporters and individuals may elect to see the Tips4Life that are one phase ahead of the phase where they currently are, and they can elect to have those next phase matches syndicated to them as a primary elective choice.
Within the Start-Up Guide for the user, each individual is prompted to leave Tips4Life for other members of the community as they complete the phase they are currently in. Tips4Life is a persistent module that is always accessible to the user. Once selecting the Tips4Life module, the patients, caregivers or supporters and individuals can do three things:
   1. Use the filter function to search the entire community database and find Tips4Life that are closest to the fields of disease, age, location, phase of concern.
   2. Use the Submit Your Tips4Life module to enter a tip that they believe will provide help and healing to community members facing the challenge of the phase that they have just gone through.
   3. Review the Tips4Life that they have added to their favorites list.
The software template on both the Tips4Life page and the smaller Tips4Life syndication applications (to mobile devices, computer desktops, pda's, etc.) contain pre-configured placement into which pre-sized advertisements can be placed and transmitted to the patients, caregivers or supporters and individuals who have filtered Tips4Life.

4. Real world book (Bridge Book). Other online health and wellness sites confine the social networking elements of their program to the computer environment. In actual real-world practice, very few patients bring laptop computers or connected digital devices into doctor's offices, examining rooms or treatment centers. Conversely, very few facilities are Internet enabled with areas for patients, caregivers and supporters or individuals and medical professionals to co-browse with a computer.

Recognizing this problem, there is an integrated method and system to automatically transform the patients, caregivers or supporters and individual's online community templates into a printed journal that serves as an organizer, note and record keeper, medical communication tool, and a progressive chronological documentation of the patients, caregivers and supporters or individual's story.
a. The system automatically transforms the user's online community templates into an organized and useful printed journal.
b. The system automatically transforms and organizes the user's online community templates into organized chapters and subjects for review and sharing with community members and medical professionals once printed.
c. The system automatically transforms and organizes the user's online notes, blogs and records for review and sharing with community members and medical professionals, caseworkers, doctors, etc., once printed. Note: Specific real-world uses of this method are to enable the patients, caregivers and supporters or individuals to note and communicate medical prescriptions issued by multiple medical professionals and have a single source from which to communicate all procedures in practice at any given time.
d. The system automatically transforms and organizes the patient, caregiver and supporters or individual's online social media templates into scrapbook pages for the purpose of personal inspiration and motivation during treatment.
e. The system automatically transforms and organizes the patients, caregivers and supporters or individual's online community templates into a memory book, in the event that the patient is not successful in overcoming their health challenges and passes away.
f. The system automatically transforms and organizes the patients, caregivers and supporters or individual's online community templates into a wellbeing or memory book that can be upgraded into a “professionally produced” coffee table book type product.

The principal method by which the patients, caregivers or supporter and individuals access and utilize the Real World Book (Bridge Book) functionality is:
The standard online templates are designed for use in the online computer world, with appropriate interaction, information architecture and features. Once the user has written and saved any part of any phase they can select the “Print My Bridge Book” function. The software will then re-conform the online templates into a creative format that is appropriate (with visual design, spacing, alignment, and orientation for standard notebooks) and a full color version of the Bridge Book can be printed.
Because the method and system is created in progressive phases, a natural structure and order is automatically created when a patient, caregiver or supporter and individual prints the Bridge Book and assembles it.
One of the online template subsets is for Medical Notes. In the printed Bridge Book this information is automatically conformed by the software to be in a consistent place and format, for review during each phase with the patients, caregivers and supporters or individual's medical professionals.
One of the online template subsets is for Goals and Community Notes. In the printed Bridge Book this information is automatically conformed by the software to be in a consistent place and format for inspiration and written guidance during each phase with medical professionals.
The online Start-Up guide prompts patients, caregivers and supporters or individuals on the ways to utilize the existing Bridge Book format and adapt it to a Memory Book, in the event that the patient succumbs to their illness.
If the patient, caregiver and supporter or individual so desires, sources and vendors who can receive the digital file of the Bridge Book and, for an online transaction fee, turn the Bridge Book into a high quality coffee table styled book, are provided as an additional service.

### BRIEF DESCRIPTION OF THE DRAWINGS

FIG. 1 represents the Home Page where a new user arrives and is able to receive an overview and introduction to the My Bridge4Life system.

FIG. 2 represents the User Registration form which users fill out in order to enter user information in the software system.

FIG. 3 represents the blank Bridge Plan Page, or home page and is also the public facing user display page.

FIG. 4 represents the User Identification module that contains the user picture, date of birth and location, as well as buttons for printing the user's Bridge Book and Start-up Guide.

FIG. 5 represents the exported user Bridge Book.

FIG. 6 represents the exported final page of the user Bridge Book that serves as a template for the user scrapbook.

FIG. 7 represents the Tips 4 Life Module which enable users to read, save favorites, write, filter and search for specific tips.

FIG. 8 represents the Tips 4 Life Module with the New Tips (most recent) window open.

FIG. 9 represents the Tips 4 Life Module with the Favorite Tips window open.

FIG. 10 represents the Tips 4 Life Module with the Write Tips window open.

FIG. 11 represents the Tips 4 Life Module with the Filter Tips window and filters open.

FIG. 12 represents the general Search results.

FIG. 13 represents the Global and Sub navigation of the My Bridge 4 Life software interface.

FIG. 14 represents the My Blog functionality.

FIG. 15 represents the My Community functionality.

FIG. 16 represents the My Medical functionality.

### DETAILED DESCRIPTION OF THE INVENTION

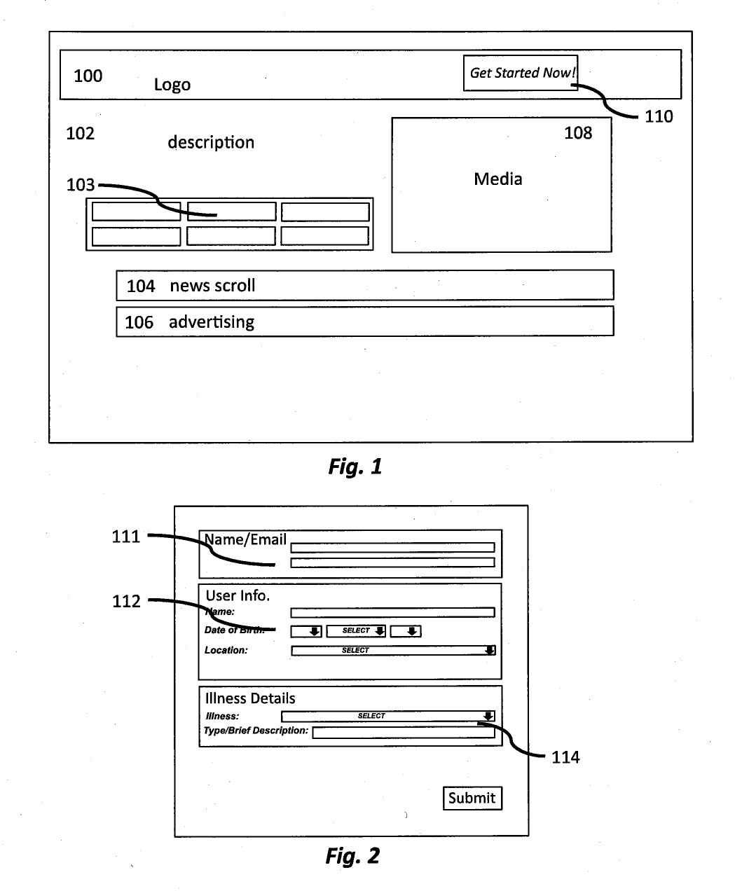

FIG. 1 represents the web Home Page where a new user arrives and is able to receive an overview and introduction to the My Bridge 4 Life system. The disclosure further describes details of the system and its functionality

Shown is the placement of the product logo on the main web page. “Description” [102] refers to the general overview copy text of the introductory Home Page and description of the system for first time visitors who are not yet registered users.

The system has a series of functional application buttons [103] available once a user has created an account. These buttons allow the user to learn about the various system elements in the program via the media window [108] to the right of buttons [103]. The media field [108] can be controlled by the user via the various buttons [103]. Some of the media elements include examples generated by the My Bridge 4 Life system that can be downloaded and reviewed by potential users.

The “news scroll” [104] is a promotional tool of the system whereby an administrator can add “up the minute” news and information to enhance the value perception of the program. The “advertising” field [106] promotes sponsors or donation funnels for the purpose of generating revenue or donations, with web links to external funnels or paths for donations, purchases and promotions.

The “get started now” button [110] launches the systems user registration form (FIG. 2).

FIG. 2 represents the User Registration form for My Bridge 4 Life. Completing this form is mandatory for the system to be able to deliver the functionality of its primary modules. Required and elective user information includes:

“Name/Email” [111]—These two field elements are required but never made public. They are the user's:
Actual name and Contact email address

“User Info.” [112]—These four elements are all public facing to the My Bridge 4 Life community. They include:
Name—This is the public name, which can be a “user” name, that protects the personal identity of the user
Date of birth—the system provides pull down menus to enter the user's actual date of birth
Location—the system provides a pull down menu to enter the user's state or country and region
“I am a”—the system provides “radio boxes” for the user to identify themselves as a Patient, Supporter, Caregiver or Individual

“Illness Details” [114]—These elements include:
Illness—the system provides a pull down menu containing many choices from which the user can select
Type/Brief Description—This in an elective field in which the user can add a type or brief description of the illness or challenge that they are facing or supporting

The Submit button [113] at the bottom of the drawing sends the user's choices in the registration form to the system's content management sub-system where it is sorted and placed in the appropriate fields for user customization.

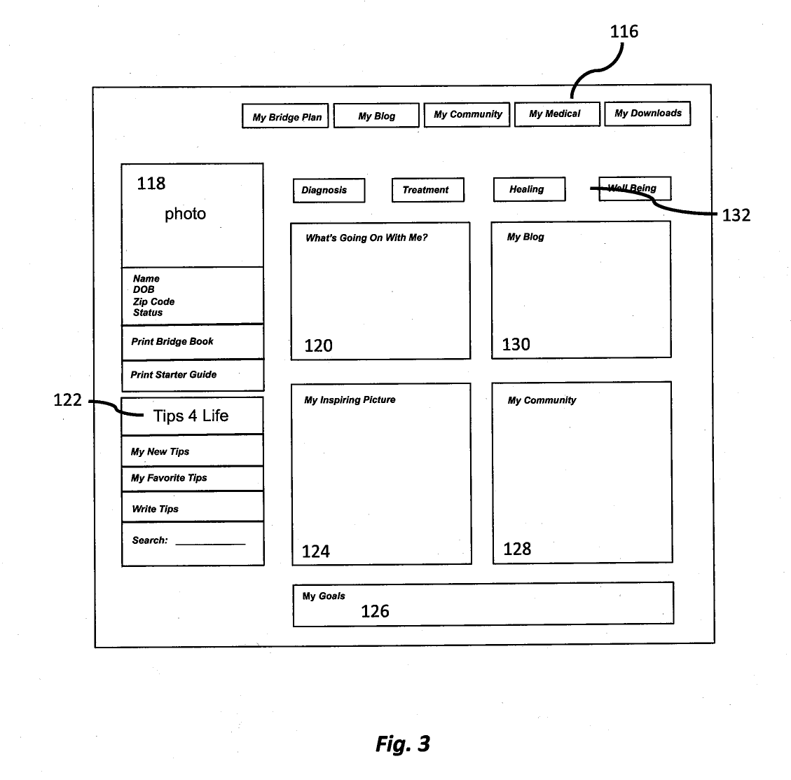

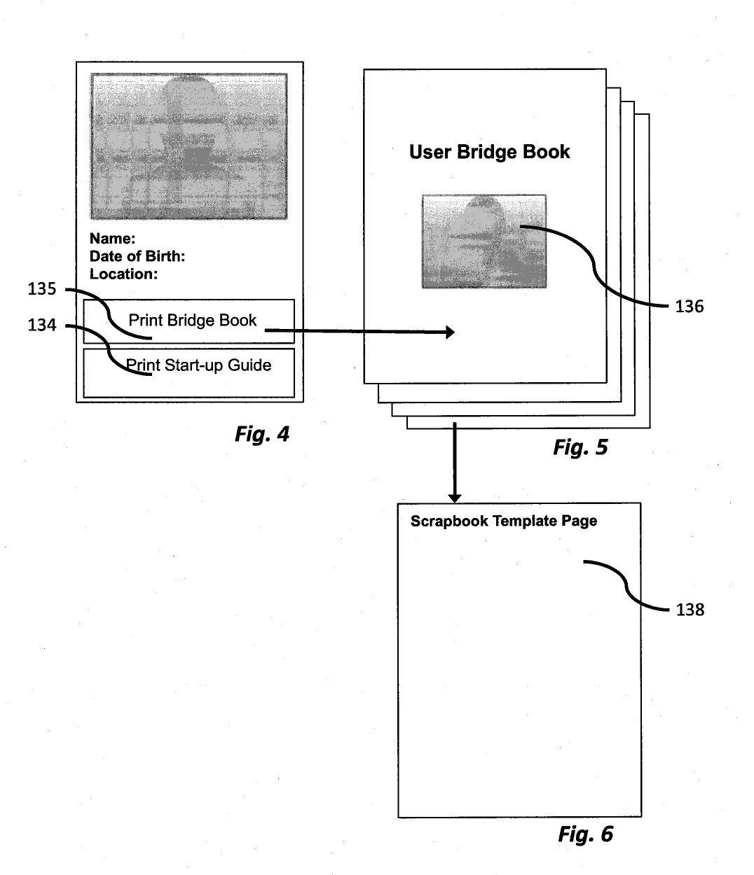

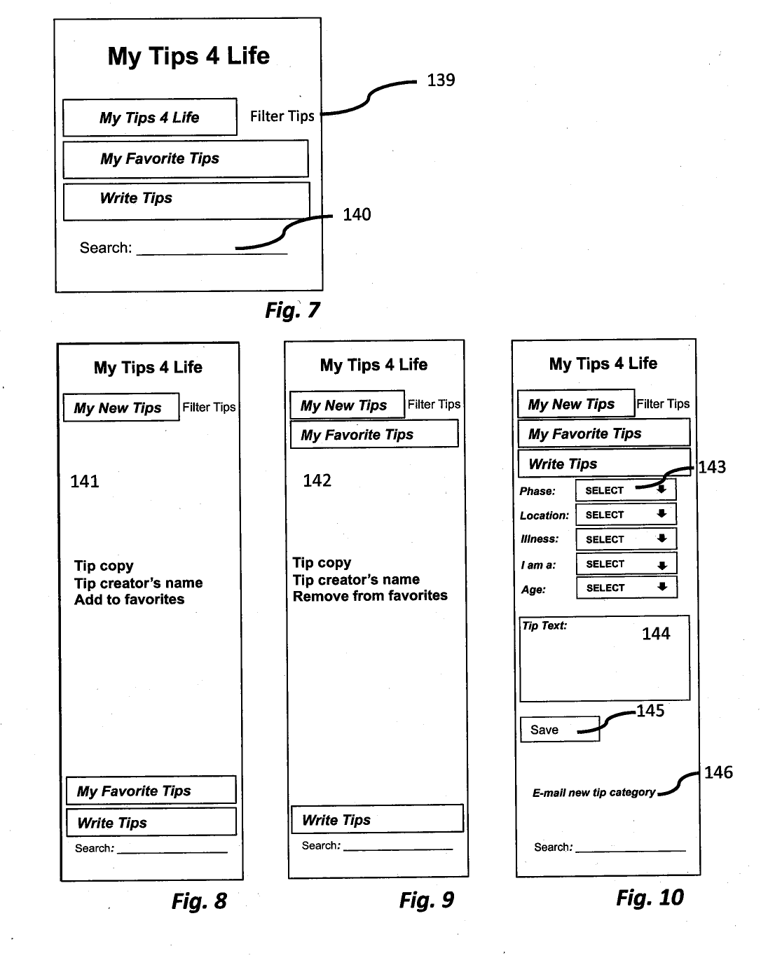

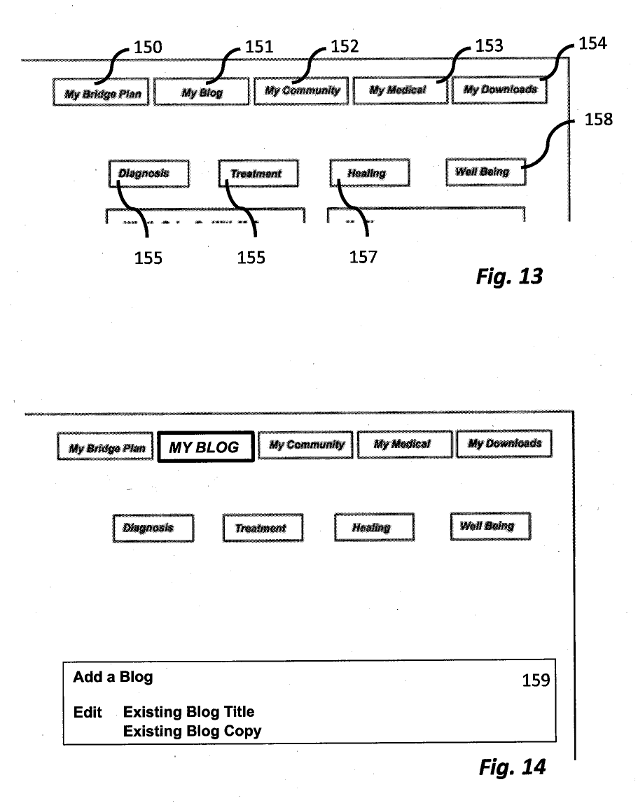

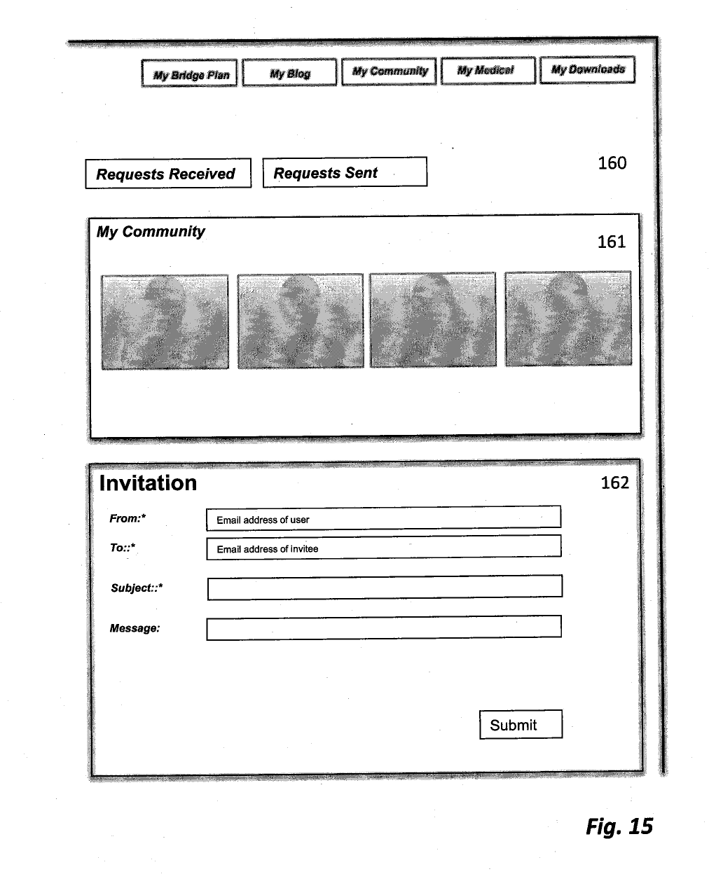

FIG. 3 represents the blank Bridge Plan Page [116] the home page and is also the public facing user display page. This is the user specific global navigation of the software system and is a persistent element that is always on screen and usable in every state of the software process. The buttons and detailed functionality are described in FIG. 13. Included is the Personal Identification module [118] for the software system. These public facing elements include:
Photo—the system enables the user to select a digital image and upload this image into the image window for visual recognition
Name, Date of Birth, Location, Illness Details—the system's content management sub-system, once a user has registered, configures and displays that user data in the correct fields in this module
Print Bridge Book and Print Start-up Guide—A greater detail of the disclosures in these features are included in FIGS. 4-6
   What's going on with me? [120]—the system's content management sub-system, once a user has registered, configures and displays that user data in the correct fields in this module, which include Illness and Type/Brief [114]
   Tips 4 Life [122]—The system has a section of the website which provides a sub system and method for searching/receiving, saving and posting health and wellness tips in each of the four phases. This is one of the primary features of the overall system. A greater detail of the disclosures in these features are included in FIGS. 7-12
   My Inspiring Picture [124]—The system enables the user to select a digital image and upload this image into the image window for the purpose of selecting and seeing an image that “makes them want to live for tomorrow”. The system provides the ability for a picture to be uploaded and displayed for each phase.
   My Goals [126]—The system provides the text editing and entry tool for the personal goals from the patient, caregiver or supporter to be entered here. These are the goals the user hopes to achieve in this phase.
   My Community [128]—The system provides the ability for an online community to be assembled. A community is a group of users. Community members are acquired via invitations that are accessed by clicking on a user's name. Details for this sub system element are shown in FIG. 15. The images and names of the user's community are displayed in this window which can be scrolled and accessed for communication purposes via this window.
   My Blog [130]—The system provides the text editing and entry tool here for the user to create text written blogs. Blog entries can include user generated key words that all global users can search. Details for this sub system element are in FIG. 14. The system provides the ability for multiple blogs to be uploaded and sorted for each phase.
   Element [132] is the sub navigation of the software system and is a persistent element that is always on screen and usable in every state of the software process. The buttons and detailed functionality are described in FIG. 13.

FIG. 4 represents the User Identification module that contains the user's picture, date of birth and location, which the system acquired during the registration process. Once that data has been received, the system software modifies the data and conforms it to display in the upper window and text fields of this persistent module.

Clicking Print Start-up Guide button [134] causes the system to download an instructional “how to” document which the user can review digitally or print as a companion element.

Print Bridge Book button [135] is a principal feature of the system. When the user clicks this button, the system software conforms the entirety of the user's written elements, saved elements, favorites, digital photographs, tips 4 life, goals, medical notes, blogs and community members and conforms this data in a single file for the creation of a printable book.

FIG. 5 represents the exported and conformed user's Bridge Book [136]. All of the data from [135], once conformed, can be printed and used in book form by the user. The page length and detail is determined by the user's activity level.

FIG. 6 represents the exported final page of the user Bridge Book [136]. Template [138] is for the user's personal scrapbook and contains the instructions on how to expand their Bridge Book [136] with this personal creative feature.

FIG. 7 represents the Tips 4 Life Module in a closed state. The system provides for two ways to search for relevancy with this primary persistent product feature.

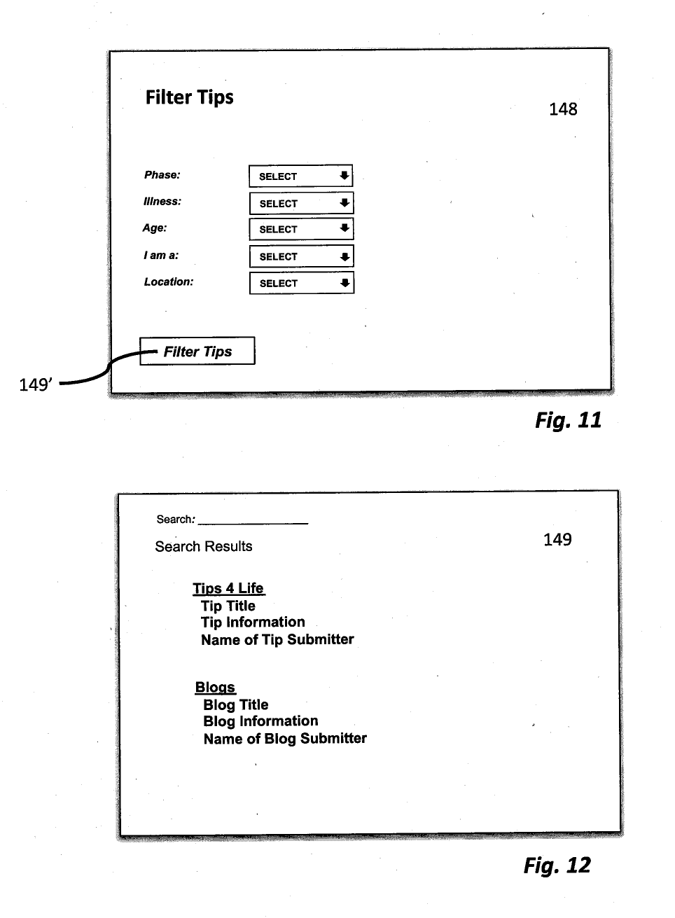

The Filter Tips feature [139] enables the user to set queries in several fields in order to find the most relevant tips. The fields are detailed are in FIG. 11. Global Search feature [140] enables the user to search for relevant keywords and phrases in all tips and blogs. The result fields are detailed in FIG. 12.

FIG. 8 represents the Tips 4 Life Module with the New Tips (most recent) window open. Field [141] represents the system's display for one of many tips that may be in the window. If the system returns many tips from a query, the software will automatically draw a scroll bar to enable the user to review them all.

Each tip contains:
Tip copy—The copy has been written by another user and is limited in word count and can include a url to another website
Tip creator's name—The system creates an active link for the name of every tip that is displayed, enabling the user to click on this name and see an image, age, illness and location of the tip writer. A second click will then open an invitation window for the user to send a “community invitation” request to the tip submitter
Add tip to favorites—The system creates an active link below every tip that is displayed, enabling the user to click on this link and add the tip to their list of favorite tips

FIG. 9 represents the Tips 4 Life Module with the user's Favorite Tips window open. Field [142] represents the system's display for one of many tips that the user may have saved for display in the favorites window. If the user saves many tips, the software will automatically draw a scroll bar to enable the user to review them all.

Each tip contains:
Tip copy—The copy has been written by another user and is limited in word count and can include a url to another website
Tip creator's name—The system creates an active link for the name of every tip that is displayed, enabling the user to click on this name and see an image, age, illness and location of the tip writer. A second click will then open an invitation window for the user to send a “community invitation” request to the tip submitter.
Remove tip from favorites—The system creates an active link below every tip that is displayed, enabling the user to click on this link and delete the tip from their list of favorite tips.

FIG. 10 represents the Tips 4 Life Module with the Write Tips window open. Field [143] comprises the information that the system requires the user to enter for each submitted tip, in order for the software to be able to sort and categorize the tips.

The information includes:
Phase—The user must select the illness phase that is current for them
Location—The user must select the location that is current for them
Illness—The user must select the illness that is current for them
I am a—The user must select from patient, caregiver, supporter, or individual
Age—The user must select the age range that is current for them

Field [144] represents the Tip Text box into which the user is able to type the body of their tip. Field [145] represents the Save function. Once the user has selected the required fields and entered tip text, clicking the save button causes the software to transfer the selections and text to the content management sub system at the server database.

Field [146] represents the Add New Illness functionality whereby a user can enter a tip for an illness that is not currently contained in the tip database. Clicking on this active link will open a text link enabling the user to email a new tip and illness to the product administrator for review and potential inclusion in the program.

FIG. 11 represents the Tips 4 Life Module's Filter Tips window and filters. Field [148] contains the categories by which the system can filter tips from a narrow (1 filter) to a wide (5 filter) search.

The categories are:
Phase—The user may select the illness phase that is current for them
Location—The user may select the location that is current for them
Illness—The user may select the illness that is current for them
I am a—The user may select from patient, caregiver, supporter, or individual.
Age—The user may select the age range that is current for them
   The Filter Tips button [149′] at the bottom of the window, when clicked, will cause the system to query the database and return results based on the user's elected parameters.

FIG. 12 represents the general Search results. Field [149] contains the attributes of the general search results window. An additional search window is always available if the user would like to initiate a new search from this window. If the system returns many tips from a query, the software will automatically draw a scroll bar to enable the user to review them all.

Each Tip 4 Life search result contains:
Add to my favorite tips—clicking on this active url will cause the system to add the tip to the user's favorite section
Tip Title—this is the brief title of the tip
Tips Information—this is the full body of the tip text
Name of Tip Submitter—this is the user name of the tip submitter
   Each blog search result contains:
Blog Title—this is the brief title of the blog
Blog Information—this is the first paragraph (length is determined by the system) of the blog text
Name of Blog Submitter—this is the user name of the blog submitter

FIG. 13 represents the Global and Sub navigation of the My Bridge 4 Life software navigation interface buttons and is a partial representation of FIG. 3. All of the user-entered data contained in each of these sections can be configured by the software system by phase using the sub navigation buttons (155-158).

The persistent global navigation includes the following buttons:

My Bridge Plan [150]—Clicking on this button will cause the system to configure and display the user's public Bridge Plan (FIG. 3).
My Blog [151]—Clicking on this button will cause the system to configure and display the user's blog entries and display them in chronological order (FIG. 14).
My Community [152]—Clicking on this button will cause the system to configure and display the user's community members, community status and invitation form (FIG. 15).
My Medical [153]—Clicking on this button will cause the system to configure and display the user's personal medical information, medical contacts, medical notes and maps/directions to the listed professionals.
My Downloads [154]—Clicking on this button will cause the system to display download options. This menu includes access to the Start-up Guide and Bridge Book and also includes a link to download the My Bridge 4 Life iPhone application from the Apple iTunes online store.
Diagnosis [155]—One of the primary features of the program is the persistent phase-based navigation. Clicking on this button will cause the system to configure and display the user's data based only on what was specifically targeted for the diagnosis phase.
Treatment [156]—Clicking on this button will cause the system to configure and display the user's data based only on what was specifically targeted for the treatment phase.
Healing [157]—Clicking on this button will cause the system to configure and display the user's data based only on what was specifically targeted for the healing phase.
Well Being [158]—Clicking on this button will cause the system to configure and display the user's data based only on what was specifically targeted for the Well Being phase. FIG. 14 represents the My Blog functionality. The blog display window [159] contains the following elements:
Add a New Blog—clicking on this link enables a user to add a new blog (this functionality only appears once at the top of the system window)
Edit—clicking on this link enables a user to edit the text for an existing blog
Existing Blog Title—This represents the title line for the blog
Existing blog copy—This represents the text copy for the blog. The system allows the blog to take many different forms, depending on user input, including text, attached images, webpage url links, etc.

FIG. 15 represents the My Community functionality. Field [160] is the location at the top of the “My Community” window where users are able to manage:
Requests Received—the system will display outstanding requests here
Requests Sent—the system will display sent (but not yet accepted) requests here
   My Community [161] is a sub window where user community member's images and names are displayed
   Invitation [162]—By filling out the fields (From [user email], To, Subject and Message [not required]) on this form, then clicking the Submit button, the user will cause the system to configure an email invitation to the email address in the “To:” field.

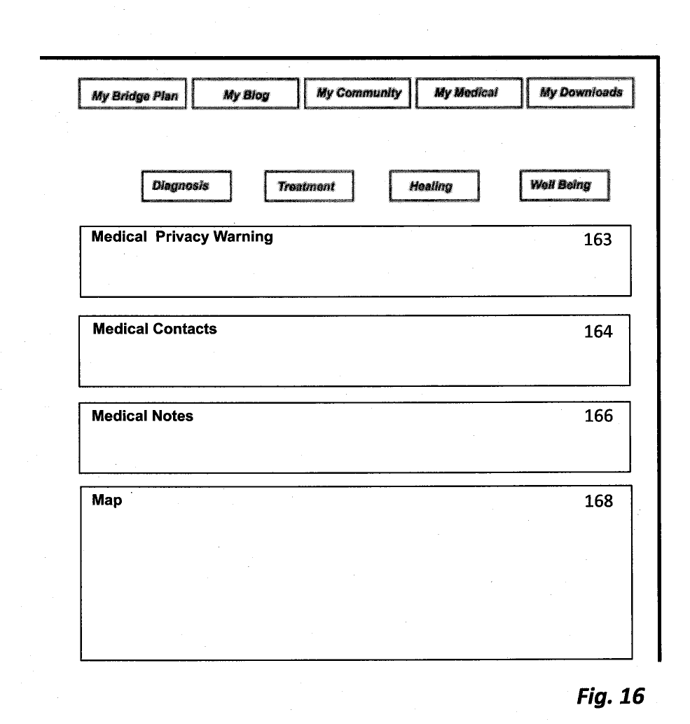

FIG. 16 represents the My Medical functionality. The system keeps this page and all of its information private for the user to gather personal notes and medical information. The system will not add or upload any of this data to any source other than the My Bridge Book to enable the user to manually print this data if so desired. Medical Privacy Warning [163]—This field includes instructional copy and assurances of privacy.

Medical Contacts [164]—This field is a section where a user can enter the full contact information for all user medical contacts and healthcare professionals.
Medical Notes [166]—This field is a section where a user can enter all relevant medical notes.
Map [168]—If the user enters a full address and zip code for medical contacts then the system will configure and display each individual medical contact location in this window.

Variations and/or modifications can be made to the parts herein described without departing from the spirit of the invention.

Having thus described the invention, I claim:

1. A phased system for transitioning an individual from diagnosis of an illness or a major life transition to wellbeing comprising, entering into a computer database information about the individual in phases including diagnosis, treatment, healing and wellbeing, the computer organizing the information into a book format.

2. The phased system of claim 1 in which the computer organizes the information into the phases of diagnosis, treatment, healing and wellbeing.

3. The phased system of claim 1 in which the information is entered into the computer by one or more of, the individual, or a caregiver or a supporter of the individual.

4. The phased system of claim 3 in which the caregiver is a medical care provider.

5. The phased system of claim 3 in which the supporter is a family member or friend of the individual.

6. The phased system of claim 1 in which the individual information comprises the individual's diagnosed illness, the phase of their illness, their age and their geographical location.

7. The phased system of claim 6 in which the computer provides a drop-down menu of illnesses from which the individual can choose one to enter into the computer database.

8. The phased system of claim 1 in which the information is entered at the time the individual enters each phase.

9. The phased system of claim 8 in which the information is updated at any time chosen by the individual, caregiver or supporter.

10. The phased system of claim 1 in which the computer creates a website and social media application containing the information.

11. The phased system of claim 1 further comprising online templates for entry of information.

12. The phased system of claim 1 further comprising a search function whereby the individual can search the global database for information about their illness and treatments for their illness.

13. The phased system of claim 1 in which the system automatically formats the data in a chronological chaptered sequence for the printing of the information in a notebook format to be used by the individual as a chronicle of their journey.

14. The phased system of claim 1 further comprising a search function whereby the individual can search the global database for advice from other individuals who have experienced their illness.

15. The phased system of claim 14 further comprising a search function whereby any registered user can search the global database for advice from other individuals who have experienced a specific illness, and filter that information by illness, phase, age, location and patients, caregivers or supporters and individuals.

16. The phased system of claim 1 further comprising an input function within the Tips4Life sub-system, whereby any user can input personal wellness tips in the global database providing advice for other individuals, the system then making that information searchable by illness, phase, age, location and patients, caregivers or supporters and individuals.

17. The phased system of claim 1 further comprising a stand alone search and input function within the Tips4Life sub-system, whereby any user can search the global database to receive advice or input into the global database to give advice by illness, phase, age, location and patients, caregivers or supporters and individuals using a stand alone computer desktop subset of the larger application.

18. The phased system of claim 17 wherein the search and input process is done with a mobile device.

19. The phased system of claim 18 wherein the mobile device is a telephone, PDA, mobile computer or other mobile device.
